(19) United States
(12) Patent Application Publication
(10) Pub. No.: US 2007/0122250 A1
(43) Pub. Date: May 31, 2007

(54) DOUBLE-HEADED SCREW

(76) Inventor: Nandor Mullner JR., Aston, PA (US)

Correspondence Address: WILLIAM H. EILBERG, THREE BALA PLAZA, SUITE 501 WEST, BALA CYNWYD, PA, 19004, US

(21) Appl. No.: 11/612,125

(22) Filed: Dec. 18, 2006

Related U.S. Application Data
(63) Continuation-in-part of application No. 11/289,253, filed on Nov. 29, 2005.

(51) Int. Cl. F16B 23/00

(52) U.S. Cl. 411/408

(57) ABSTRACT

A double-headed screw can be used for mounting a pool skimmer, or for other purposes. The screw has a threaded shank and inner and outer heads which are spaced apart to form a gap. A skimmer guard for a swimming pool, or some other generally flat structure, can be inserted within the gap without the need for special mounting tools or fasteners. The inner head has a conical shape, and may be inserted within a countersunk hole.

### CROSS-REFERENCE TO PRIOR APPLICATION

This is a continuation-in-part of U.S. patent application Ser. No. 11/289,253, filed Nov. 29, 2005.

### BACKGROUND OF THE INVENTION

The present invention comprises a double-headed screw which may be used in the field of treatment of water for swimming pools and the like. The screw is used for mounting a convenient device for preventing debris from interfering with such treatment.

Although much of this disclosure relates to the application comprising swimming pools, the double-headed screw of the invention is not limited to that application, and can be used for other purposes.

A swimming pool is commonly equipped with a skimmer, which is a device for drawing in water from the pool, filtering the water, and returning the filtered water to the pool. Skimmers can be provided both for in-ground pools and above-ground pools, and are usually located immediately outside the periphery of the pool. The skimmer receives water from an opening in the side wall of the pool.

A major problem in the operation of a skimmer is the unwanted entry of debris from the pool. At any given time, there may be various items floating in the pool, such as leaves, children's toys, or other objects. These items inevitably float towards the skimmer opening, especially in view of the negative pressure created by the flow of water into the skimmer. Thus, the debris will likely enter the skimmer, potentially causing serious clogs, and preventing the skimmer from operating properly. A severe clog may cause the circulation pump of the skimmer to burn out.

A skimmer typically has a flap, disposed in an opening of the pool wall, for regulating the flow of water into the skimmer. Entry of debris into the opening may interfere with the operation of the flap. The skimmer may also include a device for automatically dispensing chlorine into the pool. Debris from the pool may interfere with the dispensing of chlorine.

Another problem with typical skimmers is caused by children. A curious child can easily insert his or her hand into the skimmer opening, interfering with the above-described flap and/or chlorine dispenser. It is therefore necessary to provide a device which prevents such occurrences.

Various efforts have been made to solve the above problems. The typical solution is to cover the skimmer opening with a screen or strainer, as is shown, for example, in U.S. Pat. Nos. 4,140,634 and 6,214,217. While such devices, and others, do prevent much debris from entering the skimmer, and do prevent access to components within the skimmer opening, the devices are inconvenient to use, as they are attached to the skimmer opening by separate fastening devices, such as screws or nails. Thus, for both installation and removal of such devices, the user must have a tool available, such as a screwdriver.

U.S. Pat. No. 5,285,538 discloses a cover that does not need to be screwed in, but the patented cover serves to seal off the skimmer during the season in which the pool is not in use. The latter patent does not show a device which will protect a skimmer from debris when the pool is in use.

Copending U.S. patent application Ser. No. 11/180,355, filed Jul. 13, 2005, the disclosure of which is incorporated by reference herein, shows a skimmer guard which can be inserted and removed without the use of tools or fasteners. The above-described device includes a perforated portion having a peripheral lip which frictionally engages a flange formed on a frame for the skimmer opening. This device is workable as long as such a flange exists. But for pools in which the skimmer opening is not provided with such a flange, a different solution is necessary.

The present invention provides a double-headed screw which can be used to mount a skimmer guard, where the skimmer opening has no flange. The invention thus overcomes the limitation of the device shown in Ser. No. 11/180,355. The invention makes it feasible to provide a skimmer guard which, once installed, can be removed and re-installed without the use of any tool.

### SUMMARY OF THE INVENTION

The present invention comprises a double-headed screw which can be used in mounting a frame for a skimmer guard, or in other applications.

A skimmer guard covers an opening in a pool wall. This skimmer opening is bounded by a frame, the frame being attached to the pool wall by a plurality of double-headed screws made according to the present invention. The skimmer guard is installed by friction only, and without separate fasteners. The skimmer guard defines a plurality of holes which allow liquid to flow into the skimmer, while preventing the entry of debris.

Each double-headed screw has an inner head and an outer head which are spaced apart to form a gap. The screw is inserted such that the gap is forward of the frame. The skimmer guard includes a plurality of keyholes, each having a larger diameter portion and a smaller diameter portion. The skimmer guard is installed by placing the larger diameter portions over the outer heads of the double-headed screws, so that the outer heads pass through the larger diameter portions, and then by pushing the skimmer guard downward, so that some of the material of the skimmer guard becomes wedged in the gap between the heads. The skimmer guard is removed by reversing the above steps. The removal and re-installation is performed without the use of any tool, as the double-headed screws are intended to remain permanently in place.

A non-perforated skimmer cover, also having keyholes similar to those of the perforated skimmer guard, can be installed and removed in the same way. The non-perforated cover is useful during seasons when the pool is not in use, and it is desired to block all access to the skimmer opening.

The invention also includes the method of protecting a pool skimmer, the method comprising engaging a skimmer guard with an opening in the pool wall, the engagement being performed by friction only and without separate fasteners. The engagement of the skimmer guard can be accomplished by pushing the skimmer guard over a plurality of screw heads, such that the heads pass through the skimmer guard, and then pushing the skimmer guard downward until the material of the skimmer guard becomes wedged in the gap between the inner and outer heads of the screw.

The invention also includes the method wherein a perforated skimmer guard is installed, and wherein the perforated skimmer guard is removed and replaced with a similar skimmer cover which is constructed without holes. Typically, the perforated skimmer guard is installed at the beginning of the swimming season, and the non-perforated skimmer guard is installed at the end of such season.

The double-headed screw of the present invention can be a self-tapping screw, or it can have uniform, machined threads which correspond with similar threads formed in the frame.

The invention therefore has the primary object of providing a double-headed screw.

The invention has the further object of providing a double-headed screw for use in mounting a skimmer guard for a swimming pool.

The invention has the further object of providing a double-headed screw for use in mounting a frame for a skimmer guard which can be attached without the use of separate fasteners such as screws, nails, or the like.

The invention has the further object of providing a skimmer guard which can be installed without the use of tools.

The invention has the further object of prolonging the useful life of a pool skimmer, by preventing entry of debris from the pool.

The invention has the further object of providing a method of attachment and removal of a skimmer guard.

The invention has the further object of providing a convenient method of changing skimmer guards at the beginning and end of a season of swimming pool use.

The invention has the further object of providing a convenient and economical means for preventing debris from entering, and potentially clogging, a pool skimmer.

The invention has the further object of preventing harm to components located within a skimmer guard due to contact by children.

The reader skilled in the art will recognize other objects and advantages of the present invention, from a reading of the following brief description of the drawings, the detailed description of the invention, and the appended claims.

### BRIEF DESCRIPTION OF THE DRAWINGS

FIG. 1 provides a fragmentary, exploded perspective view, showing a skimmer opening of a swimming pool, the opening being equipped with a skimmer guard made according to the present invention.

FIG. 2 provides a fragmentary perspective view of an exterior portion of a swimming pool, showing the skimmer used with the present invention.

FIG. 3 provides a fragmentary cross-sectional view of a portion of the skimmer guard of the present invention, wherein the skimmer guard engages a double-headed screw which is affixed to the pool wall.

FIG. 4 provides a fragmentary cross-sectional view similar to FIG. 3, but in which the skimmer guard has been lifted relative to the double-headed screw, for removal of the skimmer guard.

FIG. 5 provides an elevational view of the double-headed screw of the present invention.

FIG. 6 provides a view, similar to that of FIG. 1, showing a non-perforated skimmer cover which is being affixed to a skimmer opening, according to the present invention.

### DETAILED DESCRIPTION OF THE INVENTION

The present invention comprises a double-headed screw which is especially useful in mounting a skimmer guard for a swimming pool. In the following description, the latter application will be described, but the invention should not be deemed limited to any particular application.

A skimmer guard comprises a perforated plate installed over a skimmer opening. Once it has been installed according to the present invention, the skimmer guard can be repeatedly removed and re-installed without the use of any tools.

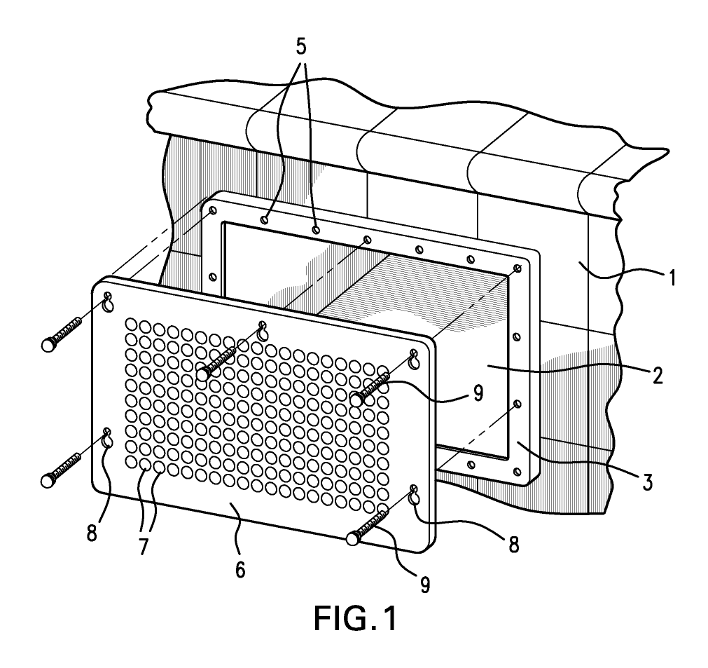

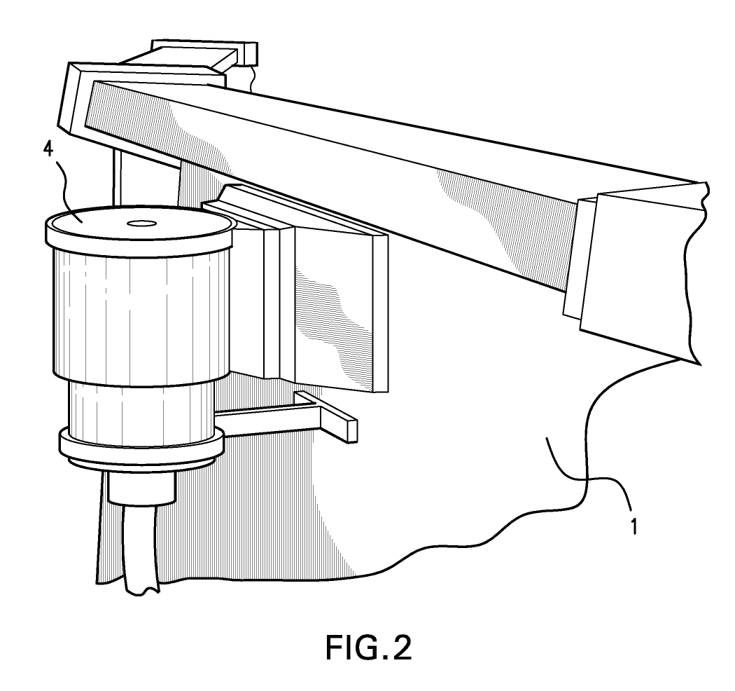

FIG. 1 shows pool wall 1 defining a skimmer opening 2. The skimmer opening provides access to skimmer 4 (see FIG. 2). That is, the skimmer opening allows water from the pool to enter the skimmer, which is located outside the periphery of the pool wall. In the illustration of FIG. 2, the pool is an above-ground structure, and the skimmer is plainly visible. The invention could also be practiced with an in-ground pool, in which case the skimmer may be located below ground level.

The skimmer opening 2 is bounded by frame 3, which is affixed to the wall, such as by screws 5, the frame being intended to comprise a permanent fixture of the pool.

A skimmer guard 6 comprises a plate having a plurality of perforations 7. The perforations are intended to remain unblocked while the skimmer guard is in use. Thus, the perforated plate essentially comprises a strainer, allowing water from the pool to flow into the skimmer, but preventing debris having a size greater than that of the perforations from entering the skimmer. The size of the debris capable of entering the skimmer is determined by the size of the holes in the skimmer guard.

The skimmer guard also inherently protects components that may be located within the skimmer opening. Such components may include a flap which regulates the flow of liquid into the skimmer, and may also include a device for dispensing chlorine into the pool. The skimmer guard prevents debris from interfering with these components, and also prevents children from reaching into the opening and damaging such components. It also prevents harm to children that may result from such contact.

The skimmer guard includes a plurality of keyholes 8, each keyhole including a smaller diameter portion and a larger diameter portion, the two portions being connected. The locations of the keyholes correspond with locations of some of the screws 5. In the embodiment shown in FIG. 1, there are five keyholes, but the number could be varied within the scope of the invention.

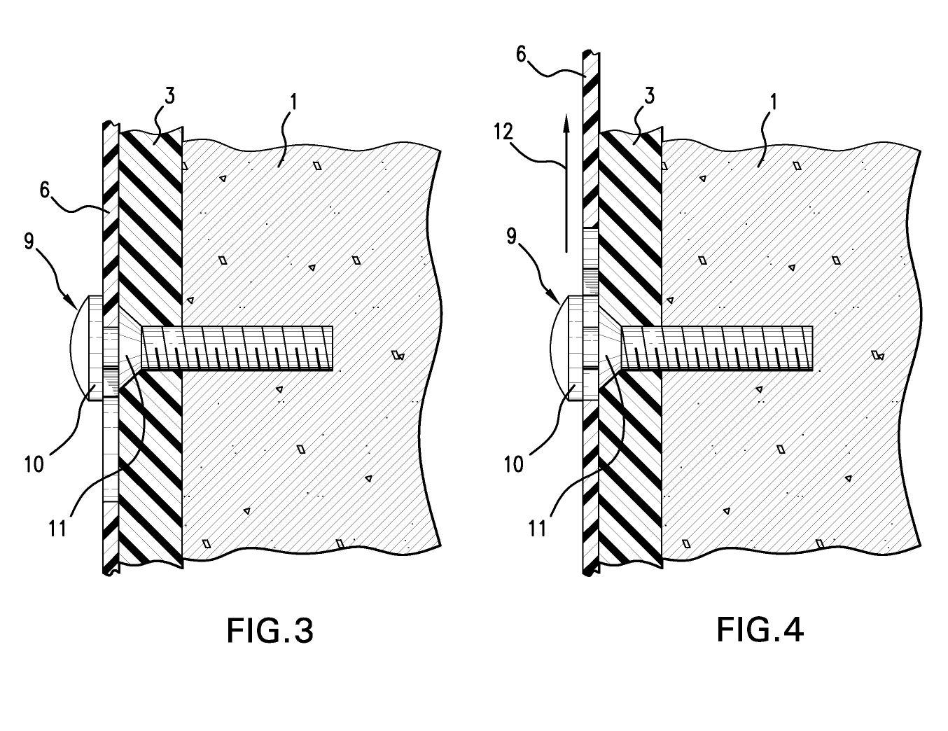

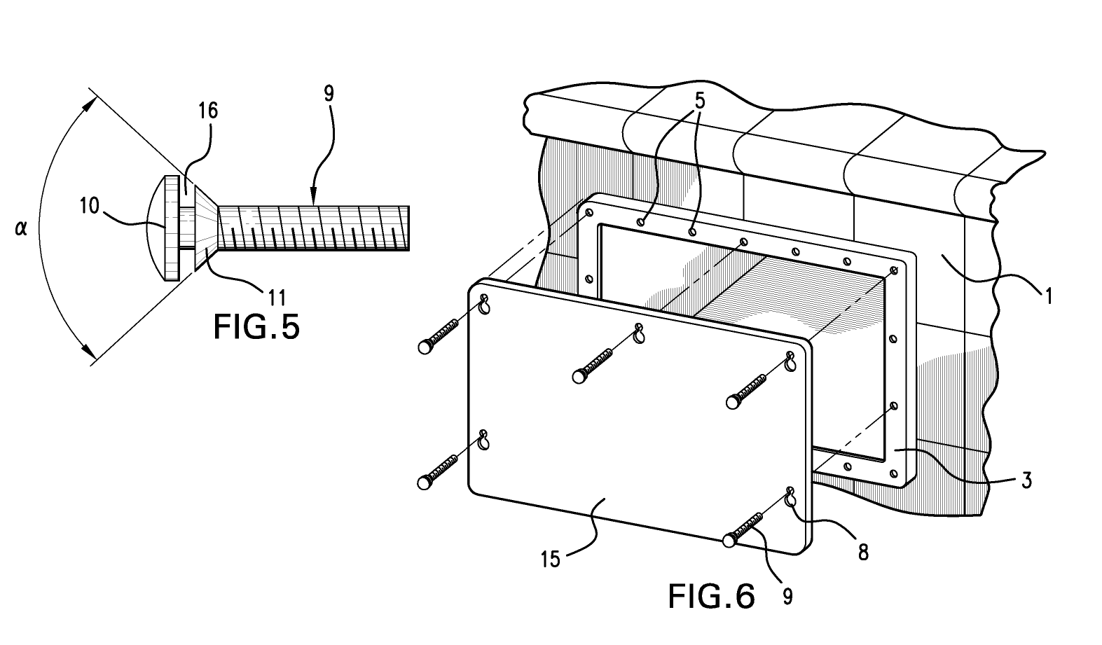

The skimmer guard is attached to the frame 3 and the pool wall 1 by a plurality of double-headed screws 9. The structure of the double-headed screws is shown in more detail in FIGS. 3-5. The double-headed screw includes a threaded shank and a pair of spaced-apart heads located at or near one end of the shank. The screw defines a gap 16 between the two heads (see FIG. 5), into which a portion of the skimmer guard can fit. A continuation of the shank is located within the gap, as shown, connecting the inner and outer heads. The inner surface of the outer head and the facing outer surface of the inner head are both generally flat, so as to accommodate the generally flat skimmer guard (or an equivalent structure) within the gap. The gap is bounded by these flat surfaces, as shown. The skimmer guard can be removed from the gap, and re-installed, without disturbing the screw. The double-headed screws are intended to replace those screws 5 which are located at positions corresponding to the keyholes 8.

The double-headed screws may be self-tapping, or they may have uniformly machined threads which correspond to similar threads formed in the frame and/or in a receptacle (not shown) in the pool wall.

In practice, many swimming pools are provided with skimmer frames such as frame 3, with screws such as screws 5. In implementing the present invention, it is intended that those screws 5 positioned at locations corresponding to the double-headed screws 9 will be discarded after being effectively replaced by the double-headed screws.

FIGS. 3 and 4 show a double-headed screw 9 inserted into the frame 3 and the pool wall 1. Each screw has an outer head 10 and a conical inner head 11. The outer head may have a bulbous shape, as shown, or it may have a different shape. The screw is screwed into the pool wall to a depth such that the inner head becomes fully embedded, or countersunk, in the frame 3, i.e. so that the inner head is flush with the outer surface of the frame. Thus, the outer head 10 and the inner head 11 together define a gap 16 (most clearly illustrated in FIG. 5) which is positioned immediately forward of the frame. Thus, a portion of the skimmer guard can be installed within this gap, and a portion of the skimmer guard remains in abutment with the frame, as shown in FIG. 3.

In FIG. 3, the skimmer guard 6 is inserted between outer head 10 and inner head 11 of the screw 9. The skimmer guard fits snugly between these two heads. The heads engage the skimmer guard at a location near and above the smaller diameter portion of the keyhole.

To remove the skimmer guard, one slides the skimmer guard upward, as indicated by arrow 12 in FIG. 4, so as to place the larger diameter portion of the keyhole in registration with the outer head 10 of screw 9. The skimmer guard can then be removed, without resistance, simply by pulling it over and away from the double-headed screw. The double-headed screw remains permanently in place. The skimmer guard can later be re-installed by sliding it back into the gap between the heads of the double-headed screw. The skimmer guard can be repeatedly removed and re-installed without moving the double-headed screw.

Thus, once the double-headed screw has been screwed into the pool wall, it need not be removed for the life of the pool. A screw driver, or other tool, is not required either to install or remove the skimmer guard. Each removal and re-installation of the skimmer guard involves pushing or pulling the skimmer guard such that the outer heads of the double-headed screws pass freely through the larger diameter openings of the keyholes.

As described in application Ser. No. 11/180,355, it is possible to provide a non-perforated skimmer guard or cover, similar to skimmer guard 6 but without perforations 7, for the purpose of protecting the skimmer during periods when the swimming pool is not in use. The pool may still be filled, or partly filled, during such periods, and the skimmer would not be operating during this time. It is therefore desirable to prevent water from entering the skimmer during this period. FIG. 6 shows such an arrangement. The non-perforated skimmer cover is designated by reference numeral 15, the other components being the same as in the embodiment of FIG. 1. The non-perforated cover still has the plurality of keyholes 8, similar to the other embodiment. Thus, both the perforated skimmer guard and the non-perforated skimmer cover can be installed and removed in the same way, i.e. by sliding the cover into the gap between the heads of the double-headed screw.

FIG. 5 shows the structure of the double-headed screw 9 in more detail. The conical inner head 11 has surfaces which form an angle α, which, in one preferred embodiment, is about 82°. The invention is not limited by this particular angle, however. The conical structure allows the inner head to become securely embedded in the material of the frame, as shown in FIGS. 3 and 4.

The present invention also includes the method of replacing a non-perforated skimmer guard with a perforated skimmer guard, as would be typically done at the beginning of the swimming season, and replacing a perforated skimmer guard with a non-perforated skimmer guard, as would be done at the end of the swimming season. The above operations could also be performed at other times, if desired. Provided that the double-headed screws have been previously and permanently installed, all of the above operations are performed without the further insertion of screws, nails, or other fastening devices, and are preferably performed without any tools. By eliminating the need to use fastening devices or tools, the present invention makes it very easy to change the skimmer guard as desired.

The invention also includes the method of installing the perforated skimmer guard over the pool wall opening. The skimmer guard is simply pushed towards the opening, such that the outer heads of the double-headed screws pass through the larger diameter portions of the keyholes, and then pushed downward so that the material above the smaller diameter portion of the keyholes becomes wedged in the gaps between the heads of the double-headed screws. At this point, engagement by friction between the skimmer guard and the screws is complete.

The skimmer guard of the present invention is preferably made of plastic. However, the invention is not limited to any specific material, and could be practiced with skimmer guards made of wood, metal, or other materials.

The invention can be modified in various ways. The specific shape of the skimmer opening could be changed, and such change would require a corresponding change in the shape of the skimmer guard. For example, the opening could be square, or even circular, in which case the skimmer guard would need to be formed with a similar shape for engagement with the skimmer frame. The number of screws 5 affixing the frame to the pool wall can be changed, as can the number of double-headed screws 9 used to affix the skimmer guard to the frame. These and other modifications, which will be apparent to the reader skilled in the art, should be considered within the spirit and scope of the following claims.

What is claimed is:

1. A double-headed screw, comprising a shank, and a pair of spaced-apart heads located in a vicinity of the shank.

2. The screw of claim 1, wherein the heads define a gap.

3. The screw of claim 1, wherein the screw includes an outer head and an inner head, the inner head having a generally conical shape.

4. The screw of claim 3, wherein the inner head has surfaces which form an angle of about 82°.

5. The screw of claim 3, wherein the outer head has a generally bulbous shape.

6. The screw of claim 2, wherein the heads have generally flat opposing surfaces on either side of the gap, wherein the gap comprises means for accommodating a generally flat structure inserted therein.

7. A double-headed screw, comprising:
a) a shank having an end,
b) an outer head, positioned in a vicinity of the end of the shank, and
c) an inner head, spaced apart from the outer head to define a gap between the inner and outer heads.

8. The screw of claim 7, wherein the inner and outer heads have generally flat surfaces, on either side of the gap, wherein the gap accommodates a generally flat structure inserted therein.

9. The screw of claim 7, wherein the inner and outer heads have different shapes.

10. The screw of claim 7, wherein the inner head has a generally conical shape.

11. The screw of claim 10, wherein the inner head comprises means for providing a countersunk head when the screw is threaded into a material.

12. The screw of claim 10, wherein the outer head has a generally bulbous shape.

13. The screw of claim 7, including a continuation of the shank located between the inner and outer heads.

14. A double-headed screw comprising:
a) a threaded shank having an end,
b) an inner head and an outer head mounted on the shank,
c) the inner and outer heads being spaced apart so as to define a gap,
wherein one of the heads has a generally conical surface suitable for insertion within a countersunk hole.

15. The screw of claim 14, wherein both the inner and outer heads have generally flat surfaces, and wherein the gap is bounded by said flat surfaces.
